(19) United States
(12) Patent Application Publication
(10) Pub. No.: US 2004/0169360 A1
(43) Pub. Date: Sep. 2, 2004

(54) Single panel airbag

(76) Inventor: Spencer William Chavez, Linden, MI (US)

Correspondence Address: DINNIN & DUNN, P.C., 2701 CAMBRIDGE COURT, STE. 500, AUBURN HILLS, MI, 48326, US

(21) Appl. No.: 10/376,922

(22) Filed: Feb. 28, 2003

(51) Int. Cl. B60R 21/16

(52) U.S. Cl. 280/743.1

(57) ABSTRACT

An airbag 10 is constructed from a single or dual fabric panel 12 and yet, when completely assembled forms a three-dimensional profile that provides greater control of the occupant kinematics due to sudden deceleration in a crash event. The dimensions of the airbag 10 may be tailored to accommodate the interior, steering wheel, or instrument panel of various vehicles without enlarging the volume or girth of the airbag 10.

### FIELD OF THE INVENTION

The present invention relates generally to safety restraint systems using airbags and particularly to a single panel airbag that improves the kinematics of the occupant during a crash event.

### BACKGROUND AND SUMMARY OF THE INVENTION

Various designs of airbags are known. For example, U.S. Pat. No. 5,087,071, herein incorporated by reference, describes a pillow or football-shaped airbag constructed from a single fabric panel. U.S. Pat. No. 5,205,583, herein incorporated by reference, also describes a pillow or football-shaped airbag constructed from a single fabric panel that includes a reinforced edge region about the opening. Although these airbag designs have proven effective, one drawback is that the final shape of the airbag does not offer a true three-dimensional profile, but is instead predicated on a two-dimensional profile. Stated another way, the airbag depth cannot be controlled separately from its width and height. In order to increase the depth of the bag to accommodate various vehicle designs, either the height or the width must be changed. Changing these dimensions may increase airbag volume and/or girth, thereby possibly altering design considerations and requiring a change in the gas output from the airbag inflator and/or a change in the spatial accommodations for storage of the pre-deployed airbag.

Other airbag designs may facilitate independent variability of the height, width or depth, but may have other disadvantages. For example, certain known airbag designs include a narrow deployment angle, or the angle that the airbag deploys from the instrument panel. The airbag design described in U.S. Pat. No. 5,316,337, herein incorporated by reference, although apparently effective, exemplifies airbags having a narrow deployment angle. To ensure the proper orientation of the airbag with regard to the occupant's head in particular, the deployment angle of the airbag is often quite narrow.

As such, it is always an object to improve the overall design of any vehicle occupant protection system to enhance the performance and safety thereof. An airbag that maximizes the restraint of the natural motion of the occupant upon the crash event is always desired. This includes the motion of the thorax as well as the neck and head of the occupant. It has been found that during a crash event, the kinematics of the occupant may be better controlled by an airbag constructed as described below. Stated another way, one object of the present invention is to minimize the forces acting upon the occupant due to deceleration.

In accordance with the present invention, an airbag is constructed from a single or dual-panel fabric and yet, when completely assembled forms a three-dimensional profile that provides improved kinematics or mitigation of the forces acting upon the occupant due to deceleration, as compared to the football-shaped airbag above, for example. The dimensions of the airbag may be tailored to accommodate the interior, steering wheel, or instrument panel of various vehicles without enlarging the volume or girth of the airbag.

Other uses and advantages of the present invention will become apparent from the detailed description provided hereinafter. It should be understood that the detailed description and specific examples, while indicating preferred embodiments of the invention, are intended for purposes of illustration only, since various changes and modifications to the invention will be apparent to those of ordinary skill in the art from this detailed description.

### BRIEF DESCRIPTION OF THE DRAWINGS

The present invention will be more fully understood from the detailed description and the accompanying drawings, wherein:

FIG. 1 is a perspective view of an assembled airbag in accordance with the present invention;

FIG. 2 is a planar view of a one-piece fabric panel that when sewn together forms an airbag in accordance with the present invention;

FIG. 3 is a perspective view of an assembled airbag in accordance with the present invention, wherein an optional throat assembly including at least one throat panel, at least one diffuser panel/assembly, and a reinforcement panel is also shown in an exploded view;

FIG. 4 is a perspective view of an assembled airbag after deployment;

FIG. 5 is a planar view of the first longitudinal portion folded over the second longitudinal portion;

FIG. 6 is a planar view of a first half of a two-part fabric panel in accordance with a second embodiment of the present invention; and

FIG. 7 is a planar view of a second half of a two-part fabric panel in accordance with a second embodiment of the present invention.

### DETAILED DESCRIPTION OF THE PREFERRED EMBODIMENT(S)

The present invention is a single panel or dual panel airbag 10 having a novel three-dimensional profile and a method of making the same. The present airbag sufficiently restrains the occupant not only in the thorax region, but also in the neck and head regions during a crash event.

A fabric panel 12 contains a first end 14 and a second end 16, end 14, wherein the first end 14 is preferably parallel to the second end 16. The first end 14 has a first endpoint 18 and a second endpoint 20, and, the second end 16 has a third endpoint 22 and a fourth endpoint 24. A longitudinal axis 26 divides the panel into a first longitudinal portion 28 and a second longitudinal portion 30 and bisects the first and second ends 14 and 16. As shown in the figures, when the fabric panel 12 is laid flat, the first longitudinal portion 28 is preferably a mirror image of the second longitudinal portion 30.

The first longitudinal portion 28 contains a first plurality of contiguous cuts or legs 32 specifically angled and sized to form the desired shape of the airbag 10. The second longitudinal portion 30 also contains a second plurality of contiguous cuts or legs 34 equal or substantially equivalent in angle and length to those of the first plurality of cuts 32. Each leg of the first plurality of legs 32 and of the second plurality of legs 34 is connected to a respective end of another leg or to an endpoint of the first end 14 or the second end 16.

Referring to FIG. 2, the first plurality of cuts 32 is defined as follows. A first leg 36, also shown as B, extends from the first endpoint 18 and forms an obtuse angle with the first end 14. A second leg 38, also shown as D, extends from the first leg 36 and forms a first apex 40 at the juncture of the first and second legs, wherein the first apex 40 extends outwardly relative to the longitudinal axis 26. A third leg 42, also shown as A, extends from the second leg 38 and forms a second apex 44 at the juncture of the second and third legs, wherein the second apex 44 also extends outwardly away from the longitudinal axis 26. A fourth leg 46, preferably equal or substantially equal to the sum of the lengths of legs 36, 38, and 42, extends from the third leg 42 and forms a third apex 48 at the juncture of the third and fourth legs, wherein the third apex 48 extends inwardly toward the longitudinal axis 26. The fourth leg 46 is also joined to the third endpoint 22 of the second end 16 and preferably tapers outwardly relative to axis 26 from apex 48 to endpoint 22.

Also referring to FIG. 2, the second plurality of cuts 34 is defined as follows. A fifth leg 58, equal or approximately equal in length to the first leg 36, extends from the second endpoint 20 and forms an obtuse angle with the first end 14. A sixth leg 60, equal or approximately equal in length to the second leg 38, extends from the fifth leg 58 and forms a fourth apex 62 at the juncture of the fifth and sixth legs. The fourth apex 62 extends outwardly relative to the longitudinal axis 26 and is equal or approximately equal to the angle of the first apex 40. A seventh leg 64, equal or approximately equal in length to the third leg 42, extends from the sixth leg 60 and forms a fifth apex 66 at the juncture of the sixth and seventh legs. The fifth apex 66 also extends outwardly away from the longitudinal axis 26 and is equal or approximately equal to the angle of the second apex 44.

Optional tapering of both the fourth leg 46 and the eighth leg 68 results from a narrowing of the distance between apices 48 and 70, or dimension “E”. Narrowing the dimension E, or the bottom width of the airbag eliminates biased folding requirements to increase initial thorax or torso contact with the bottom part of the airbag thereby enhancing deceleration of the occupant upon a crash event. Stated another way, the airbag may be folded in a standard accordian fold without employing a tether to direct the deployment angle of the airbag. Nevertheless, even without the tapered legs, the kinematics relative to restraint of the thorax, hips, neck, and head of an occupant is still improved relative to other state of the art airbags.

An eighth leg 68, preferably equal or substantially equal to the fourth leg 46 and to the sum of the lengths of legs 58, 60, and 64, extends from the seventh leg 64 and forms a sixth apex 70 at the juncture of the seventh and eighth legs, wherein the sixth apex 70 extends inwardly toward the longitudinal axis 26. The eighth leg 68 is also joined to the fourth endpoint 24 of the second end 16 and preferably tapers outwardly relative to axis 26 from apex 70 to endpoint 24. In one embodiment, the total length of the sum of legs 58, 60, and 64, and therefore leg 68 is essentially the same length as that of the fourth leg 46.

A first angle 21, formed between a co-linear extension 23 of edge 14 extending from endpoint 18 and a co-linear extension 25 of first leg 36 extending from apex 40, preferably ranges from 0 to 45 degrees depending on design specifications. Stated another way, the first leg 36 extends from the first end 14 at an angle of about 0 to 45 degrees, more preferably at 5 to 40 degrees, and even more preferably at an angle of about 32 degrees. In the same way, the fifth leg 58 also extends from the first end 14 to form a second angle 59 of about 0 to 45 degrees, more preferably at 5 to 40 degrees, and even more preferably at about 32 degrees. Angles 21 and 59 are therefore substantially equal. Given the symmetry of portions 28 and 30, a natural corollary is that the angles defined by apices 40 and 62 are also equal or substantially equal.

A third angle 43 formed between the third leg 42 and the fourth leg 46, or the angle formed at apex 48, is preferably about 90 to 130 degrees, and is more preferably about 125 degrees. Similarly, a fourth angle 69 formed between the seventh leg 64 and the eighth leg 68, or the angle formed at the apex 70, is also preferably about 90 to 130 degrees, and is more preferably about 125 degrees. Angles 43 and 69 are therefore substantially equal. Again, given the symmetry of portions 28 and 30, a natural corollary is that the angles defined by apices 44 and 66 are equal or substantially equal, as are the angles defined by apices 48 and 70.

The total length of A+B+D and therefore counterpart legs A′+B′+D′ is preferably 700 to 1800 millimeters and is more preferably about 1000 millimeters. The lengths of C and E preferably range from 400 to 1500 millimeters and are more preferably around 600 to 800 millimeters and even more preferably about 700 millimeters. Customizing the lengths of legs 36, 38, and 42, and their symmetrical counterparts 58, 60, and 64 facilitates adjustment of the height, width, and depth of the airbag, depending on the respective design criteria such as steering wheel clearance, etc. Stated another way, the adjustment of legs A, D, B, C, and E tailors the bottom depth, the height, the top depth, the top width, and the bottom width, respectively. Therefore, the use of the present airbag can be facilitated within any vehicle interior or configuration by simply varying the respective lengths given above as determined by the interior geometry.

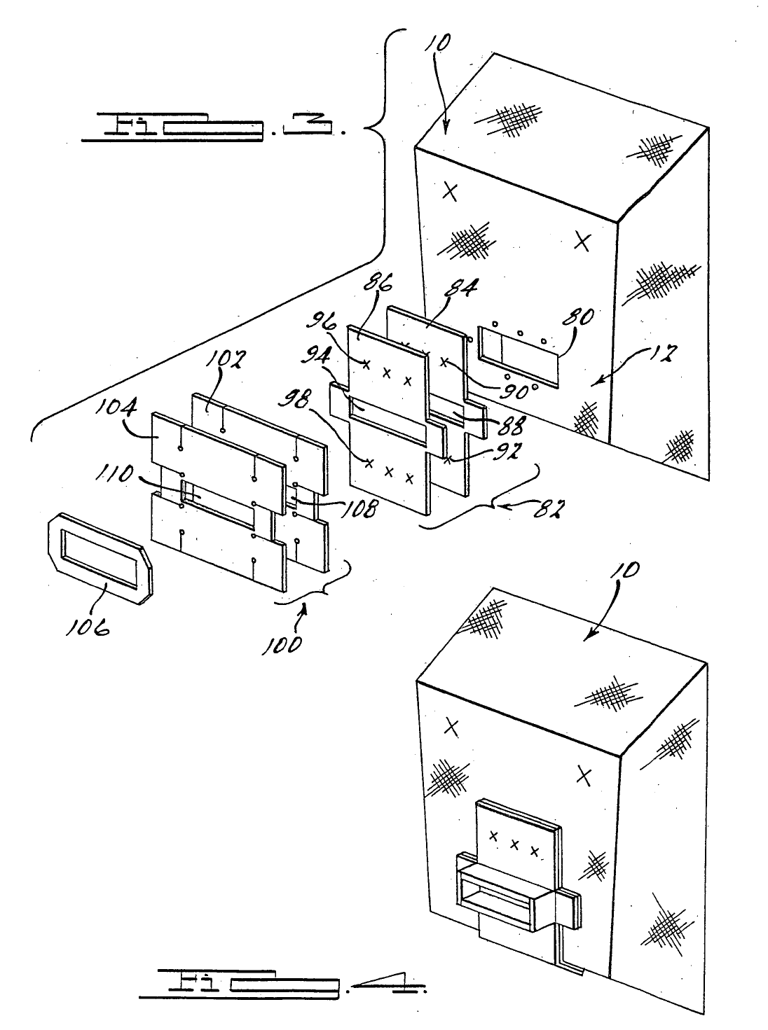

Referring to FIG. 3, the airbag 10 in yet another aspect of the invention, further contains a diffuser assembly 82 that when assembled is fixed or sewn about the first window portion 80 of the fabric panel 12. The diffuser assembly 82 contains at least a first diffuser panel 84 and preferably also contains a second diffuser panel 86. The first diffuser panel 84 contains a second window portion 88 smaller than the first window portion 80 of the fabric panel 12 to permit the flow of gas therethrough. A first plurality of crosscuts 90 are preferably formed in parallel orientation and along the length of the second window portion 88. A second plurality of crosscuts 92 are preferably formed in parallel orientation and along the length of the second window portion 88, on a side opposite to the first plurality of crosscuts 90. The second diffuser panel 86 is formed in the same way as the first diffuser panel 84. The second diffuser panel 86 contains a third window portion 94 smaller than the first window portion 80 of the fabric panel 12, to permit the flow of gas. A third plurality of crosscuts 96 are preferably formed in parallel orientation and along the length of the third window portion 94. A fourth plurality of crosscuts 98 are preferably formed in parallel orientation and along the length of the third window portion 94, on a side opposite to the third plurality of crosscuts 96. As shown in FIG. 4, the diffuser assembly 82 is sewn about the first window portion 80 of the fabric panel 12 wherein the second window portion 88 and if desired, the third window portion 94 overlay the first window portion 80.

The various plurality of crosscuts, oriented above the first window portion 80, facilitate radial flow as well as linear flow into the cushion. As a result, the center of the cushion inflates slower than the rest of the bag whereby the bottom portion of the airbag 10 deploys prior to the top portion. The airbag 10 thus makes contact with the abdomen of the occupant early in the crash event and begins to provide restraint. By absorbing this energy from the occupant relatively quicker than state of the art airbags, the peak decelerations experienced during the crash event can be minimized, thereby also reducing their corresponding forces on the occupant and improving the occupant's probability of avoiding injury due to the crash event.

The primary function of the diffuser 82 is to divert the gas generated from the airbag inflator. Diverting the gas forces the cushion to deploy in a radial rather than linear fashion. As a result, the gas enters the airbag travelling upwardly, downwardly, and linearly with a relatively slower inflation of the center of the cushion as compared to airbags inflatable primarily by linear gas flow.

If desired, a throat assembly 100 is formed from at least a first throat panel 102 and preferably a second throat panel 104. A throat reinforcement panel 106 is sewn about the diffuser assembly 82 without obscuring the various plurality of crosscuts, and strengthens the area of the fabric panel 12 attached to the throat assembly 100. The first throat panel 102 contains a fourth window portion 108 sufficiently sized to cover both the underlying diffuser window portions and the underlying pluralities of crosscuts. If a second throat panel is desired, the second throat panel 104 contains a fifth window portion 110 approximately equivalent in size to the fourth window portion 108. As also shown in FIG. 4, when assembling the airbag 10, the first and second throat panels are preferably sewn about the first window portion 80 with the reinforcement panel sewn over the complete throat assembly 100. The throat assembly 100 is optional, but is advantageous in that it may be used to control the deployment angle of the cushion. Additionally, the throat assembly 100 may also be used to offset the airbag 10 with respect to the housing. Quite often, due to vehicle packaging constraints, the passenger airbag 10 must be packaged deep in the instrument panel. As a result, the cushion must be offset to ensure cushion integrity and position.

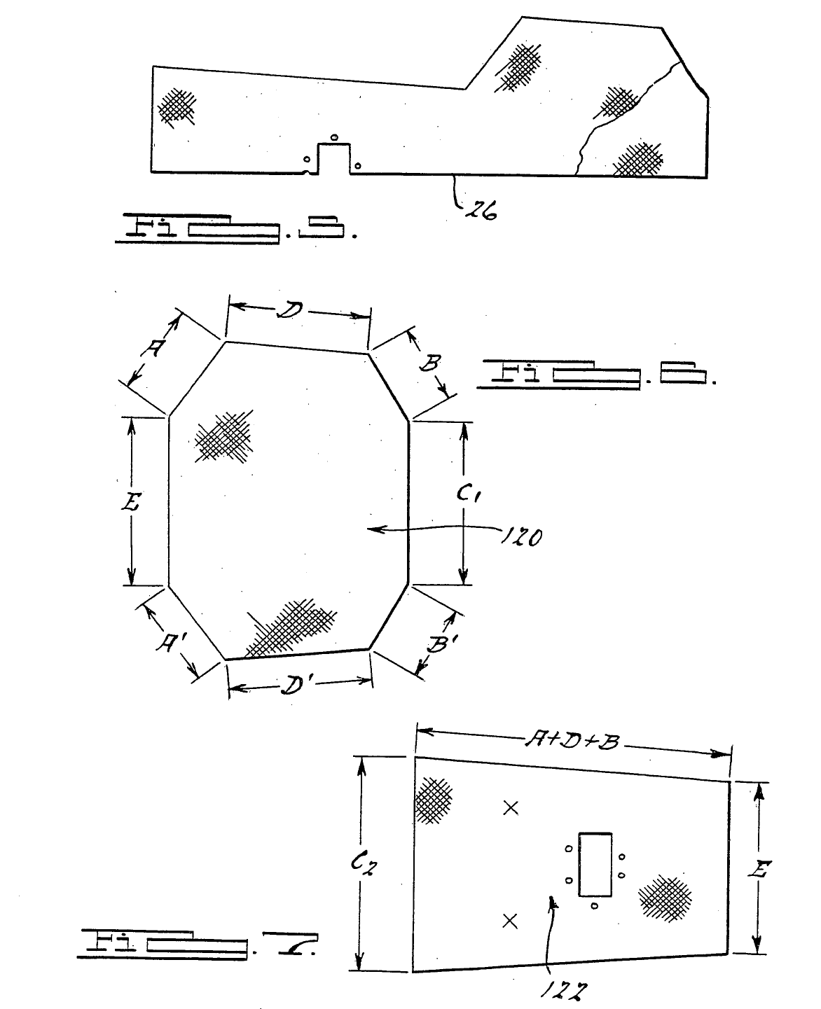

As shown in FIG. 5, the various legs in the fabric panel 12 may be formed by overlaying the first longitudinal portion 28 over the second longitudinal portion 30 to form a fold along the longitudinal axis 26, and then making a series of cuts over the resultant layered portion. Because each longitudinal portion 28 and 30 is essentially a mirror image of the other, only one set of cuts are required thereby significantly simplifying the manufacturing process. Once the cuts are made, the fabric panel 12 is unfolded and the seams are sewn as next described.

The fabric panel 12 is made from materials well known in the art as exemplified in the references referred to and incorporated herein. For example, the airbag components described herein may be formed from nylon and/or polymeric weaves. Exemplary nylon weaves include those formed from 630, 420, and/or 210 denier silicone-coated woven fabrics. When sewing the airbag, end 14 is preferably first mated with end 16 and sewn together along each edge. Fourth leg 46 is then folded along or mated with the contours of legs 36, 38, and 42 and sewn thereto. In the same way, eighth leg 68 is also sewn along the contours of legs 58, 60, and 64. Given that the lengths of legs 46 and 64 approximate the total lengths of their complementary legs 36, 38, and 42, and, 58, 60, and 64, respectively, the resulting airbag when deployed assumes a three-dimensional shape providing improved kinematics.

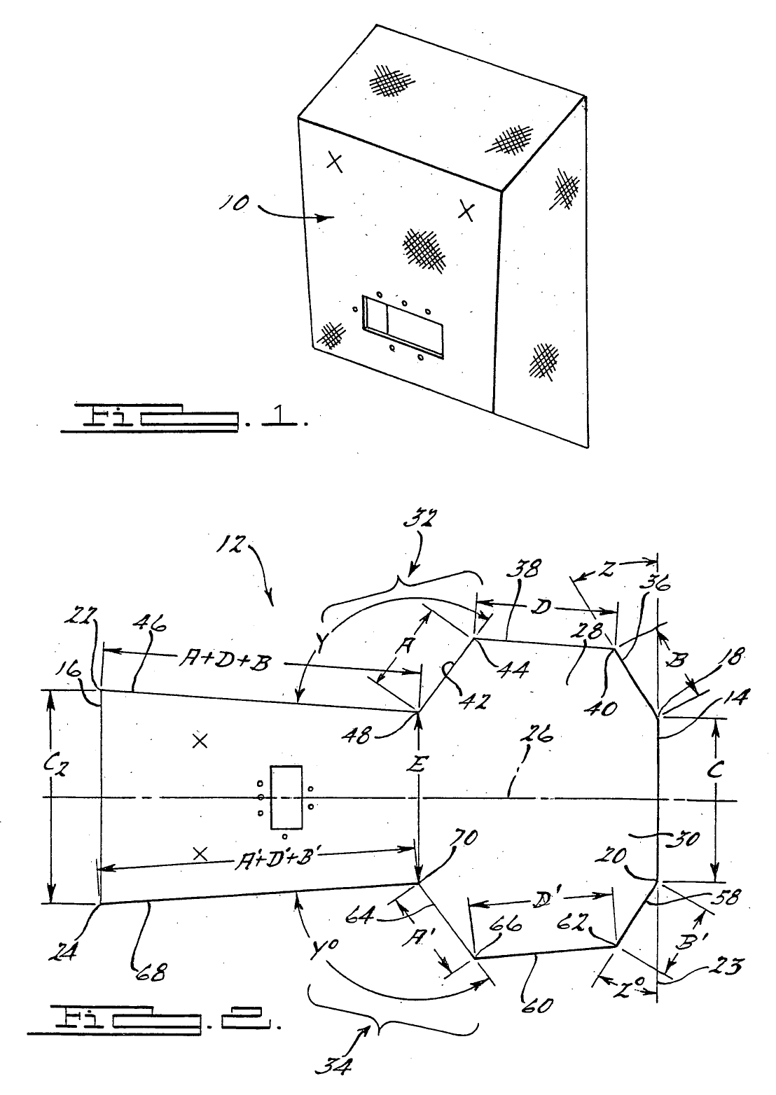

In yet another embodiment, the airbag may contain two panels rather than one, as shown in FIGS. 6 and 7. The dimensions are essentially equivalent to those described for the single panel airbag described above and shown in FIGS. 1 and 2 for example. As shown in FIGS. 6 and 7, the first panel 120 is sewn to the second panel 122 along the dimension characterized as “E”, or along a line extending through third apex 48 and sixth apex 70. Additionally, a diffuser and/or throat assembly may also be incorporated as described above.

The airbag 10 may then be attached to the inflator by means known in the art. To illustrate, the inflator may contain a flange or ring that in conjunction with the airbag module fixes the throat portion or opening of the airbag 10 about the inflator thereby facilitating inflation of the airbag 10 upon operation of the vehicle occupant protection system. See FIG. 3.

In accordance with the present invention, three-dimensional tailoring of the airbag relative to width, length and depth is facilitated without increasing the cushion volume or girth. This is accomplished by simply altering the lengths of legs 36, 38, and 42 (and corresponding legs 58, 60, and 64, respectively) to modify the airbag upper depth, height, and lower depth, respectively. On the other hand, the upper and lower width of the airbag may be respectively modified by altering the edges 14 and 16 or by altering the distance between apices 48 and 70 (dimension “E”). This flexibility is especially important when adapting a standard cushion to many different vehicle environments or spatial accommodations. Furthermore, the profile of the cushion and its deployment characteristics improve occupant kinematics as compared with two-dimensional airbag designs (e.g. designs based on width and height). For example, an airbag constructed in accordance with the present invention targets early restraint in the thorax and hip region while inhibiting contact with the arms. Early restraint of the thorax and hip region inhibits forward translation of the knees into the knee bolster. Other benefits include manufacturing advantages such as improved nesting and fabric utilization thereby simplifying manufacturing and reducing material waste.

While specific embodiments of the instant invention have been described in detail, those with ordinary skill in the art will appreciate that various modifications and alternatives to those details could be developed in light of the overall teachings of this disclosure. Accordingly, the particular arrangements disclosed are meant to be illustrative only and not limiting as to the scope of the invention, which is to be given the full breadth of the appended claims and any and all equivalents thereof.

What is claimed is:

1. An airbag for a vehicle occupant protection system comprising:
a fabric panel containing a first window, a longitudinal axis bisecting said fabric panel to form a first longitudinal section and a second longitudinal section wherein said second longitudinal section is substantially a mirror image of said first longitudinal section, a first end having a first endpoint and a second endpoint, and, a second end having a third endpoint and a fourth endpoint;
a first plurality of legs forming a first contiguous outer edge on said fabric panel from said first endpoint to said third endpoint;
a first leg within said first plurality of legs, the first leg extending from said first end point to form an obtuse angle relative to said first end, said first leg extending from said first end point at an angle ranging from 0 to 45 degrees;
a second leg within said first plurality of legs, the second leg extending from the first leg to form a first apex at the juncture of the first and second legs, wherein said first apex extends outwardly away from the longitudinal axis;
a third leg within said first plurality of legs, the third leg extending from the second leg to form a second apex at the juncture of the second and third legs, wherein said second apex extends outwardly away from the longitudinal axis;
a fourth leg within said first plurality of legs, the fourth leg extending from the third leg to form a third apex at the juncture of the third and fourth legs, wherein said third apex extends inwardly toward the longitudinal axis and said fourth leg is approximately equal to the sum of the lengths of said first, second, and third legs, and, said third leg and said fourth leg form an angle ranging from 90 to 130 degrees therebetween,
wherein upon assembly of the airbag, said fourth leg is sewn along the contours of the first, second, and third legs along their respective lengths; and
a second plurality of legs forming a second contiguous edge extending from the second end point to the fourth endpoint, said second plurality of legs corresponding in number to the first plurality of legs such that said second plurality of legs contains four legs respectively corresponding in length and angular orientation to the first through fourth legs of the first plurality of legs,
wherein upon assembly, the four legs of said second plurality of legs are sewn together in the same way as the first plurality of legs and said first end is sewn to the second end along their respective lengths.

2. An airbag for a vehicle occupant protection system formed by a method comprising the steps of:
folding a single fabric panel in half to create a fold and an outer edge opposite the fold, the folded fabric panel having a first end and a second end and a first and a second layer of fabric;
cutting a gas flow window into the fold through both the first and the second layer proximate or near the second end;
cutting a first leg through the outer edge of the first and second layers of the folded fabric panel, the first leg extending away from the fold and from the first end, and the first leg extending at an angle ranging from 0 to 45 degrees;
cutting a second leg through the outer edge of the first and second layers of the folded fabric panel and extending from the first leg to form a first juncture, wherein the juncture of the first and second legs creates a first apex extending away from the fold;
cutting a third leg through the outer edge of the first and second layers of the folded fabric panel and extending from the second leg to form a second juncture, wherein the second juncture of the second and third legs creates a second apex extending away from the fold;
cutting a fourth leg through the outer edge of the first and second layers of the folded fabric panel and extending from the third leg to form a third juncture, wherein the juncture of the third and the fourth legs creates a third apex extending away from the fold;
unfolding the fabric panel to provide a first and second longitudinal portion divided by a longitudinal axis along the prior fold, both the first and second longitudinal portions mirror images of the other wherein each longitudinal portion has four legs corresponding to the cuts described above;
sewing the first end to the second end across the first and second longitudinal portions;
sewing the fourth leg of the first longitudinal portion along the first, second, and third legs of the first longitudinal portion;
sewing the fourth leg of the second longitudinal portion along the first, second, and third legs of the second longitudinal portion;
wherein the sewn legs extend end to end and the gas flow window is open after the sewing steps are completed.

3. The airbag of claim 1 further comprising a diffuser assembly, said diffuser assembly comprising at least one diffuser panel, said first diffuser panel comprising a second window having a given length, a first plurality of crosshatch apertures along one side of and along the length of the second window, and a second plurality of crosshatch apertures along the length of the second window and along the side opposite of the first plurality of crosshatch apertures,
wherein upon assembly, the diffuser assembly is sewn on the fabric panel whereby the second window, and the first and second pluralities of crosshatch apertures are superimposed over said first window of said fabric panel.

4. The airbag of claim 3, said diffuser assembly further comprising a second diffuser panel, said second diffuser panel comprising a third window having a given length, a third plurality of crosshatch apertures along one side of and along the length of the third window, and a fourth plurality of crosshatch apertures along the length of the third window and along the side opposite of the third plurality of crosshatch apertures,
wherein upon assembly, the diffuser assembly is sewn on the fabric panel whereby the second and third windows, and the first, second, third, and fourth pluralities of crosshatch apertures are superimposed over said first window of said fabric panel.

5. The airbag of claim 1 further comprising a throat assembly sewn over said diffuser assembly, said throat assembly comprising a reinforcement panel sewn over said first window and at least one throat panel, said throat panel comprising a fourth window superimposed over said first window.

6. The airbag of claim 5, said throat assembly further comprising a second throat panel, said throat panel comprising a fifth window superimposed over said first throat panel and said fourth window.

7. A method of forming an airbag comprising the steps of:
folding a single fabric panel in half to create a fold and an outer edge opposite the fold, the folded fabric panel having a first end and a second end and a first and a second layer of fabric;
cutting a gas flow window into the fold through both the first and the second layer proximate or near the second end;
cutting a first leg through the outer edge of the first and second layers of the folded fabric panel, the first leg extending away from the fold and from the first end, and the first leg extending at an angle ranging from 0 to 45 degrees;
cutting a second leg through the outer edge of the first and second layers of the folded fabric panel and extending from the first leg to form a first juncture, wherein the juncture of the first and second legs creates a first apex extending away from the fold;
cutting a third leg through the outer edge of the first and second layers of the folded fabric panel and extending from the second leg to form a second juncture, wherein the second juncture of the second and third legs creates a second apex extending away from the fold;
cutting a fourth leg through the outer edge of the first and second layers of the folded fabric panel and extending from the third leg to form a third juncture, wherein the juncture of the third and the fourth legs creates a third apex extending away from the fold;
unfolding the fabric panel to provide a first and second longitudinal portion divided by a longitudinal axis along the prior fold, both the first and second longitudinal portions mirror images of the other wherein each longitudinal portion has four legs corresponding to the cuts described above;
sewing the first end to the second end across the first and second longitudinal portions;
sewing the fourth leg of the first longitudinal portion along the first, second, and third legs of the first longitudinal portion;
sewing the fourth leg of the second longitudinal portion along the first, second, and third legs of the second longitudinal portion;
wherein the sewn legs extend end to end and the gas flow window is open after the sewing steps are completed.
